(19) United States
(12) Patent Application Publication
(10) Pub. No.: US 2007/0205537 A1
(43) Pub. Date: Sep. 6, 2007

(54) Mandrel for thermoplastic tubing manufacture and method relating thereto

(75) Inventor: Brett D. Steen, Signal Mountain, TN (US)

Correspondence Address: GORDON & JACOBSON, P.C., 60 LONG RIDGE ROAD, SUITE 407, STAMFORD, CT, 06902, US

(73) Assignee: Phelps Dodge High Performance Conductors

(21) Appl. No.: 11/367,970

(22) Filed: Mar. 3, 2006

(51) Int. Cl. B28B 7/30

(52) U.S. Cl. 264/313; 425/403; 249/134; 264/219

(57) ABSTRACT

A mandrel for the extrusion of thermoplastic tubing includes a metal wire, an optional plated barrier material over the wire, and a polymer coating over the wire or barrier material. The polymer coating is preferably a thermoset polyimide resin with embedded PTFE particles. The PTFE particles are preferably concentrated in the upper surface of the polyimide resin and purer polyimide resin is concentrated at the lower surface in contact with the metal. In use, a thermoplastic is extruded over the mandrel. The polymer coating seals the metal surface and due to the location of the PTFE particles, the polymer bonds strongly to the wire but does not bond with the plastic being extruded thereover. Under appropriate tension, the polymer-coated metal mandrel is elongated and drawn down in diameter to release the thermoplastic tubing from the mandrel.

### BACKGROUND OF THE INVENTION

1. Field of the Invention

This invention relates broadly to apparatus and method for formation of a mandrel and plastic tubing. More particularly, this invention relates to a mandrel for plastic tubing formation and a method related thereto. The invention is also particularly relevant to the manufacture of tubing for medical applications.

2. State of the Art

For certain plastic tubing, particularly for medical use, the inner diameter of the tubing often must be held to a tight tolerance. In order to form the plastic tubing a thermoplastic material is extruded over a wire mandrel. The outer diameter of the mandrel defines the inner diameter of the tubing. The tubing is formed only when the coated mandrel is cut to a discrete length and then the mandrel is placed under sufficient tension to cause elongation of the mandrel thereby drawing it down to a smaller outer diameter. The mandrel then separates from the thermoplastic material and is removed from within the thermoplastic material, resulting in a thermoplastic tubing with the required inner diameter.

Historically, wire mandrels for the manufacture of medical-grade tubing have been constructed of silver-plated annealed copper. The copper can readily be formed to the desired outer diameter and has a modulus with the desired stress and strain characteristics such that when under tension it undergoes the required drawing down. The silver-plating acts as a biocompatible surface over the relatively more toxic copper metal. However, even with controlled drawing, a bare metal mandrel has problems with silver and copper particles separating from the surface of the mandrel and contaminating the inner surface of the extruded tubing. In addition, the metal surface of the mandrel has other problems: surface imperfections are mirrored into the inner surface of the tubing, the surface is difficult to clean and dirt on the surface is drawn into the extruded tubing, the surface has a low resistance to damage, and the surface does not deter adhesion from the soft plastic of the extrusion.

### SUMMARY OF THE INVENTION

It is therefore an object of the invention to provide a mandrel which allows the manufacture of tubing without contaminating the tubing with metal particles.

It is another object of the invention to provide a mandrel of which releases easily from the tubing formed thereon.

It is a further object of the invention to provide a method of manufacturing a mandrel which provides the above advantages.

In accord with these objects, which will be discussed in detail below, a metal mandrel wire, preferably made from an annealed metal that easily elongates under tension. The mandrel is coated with a polymer coating comprising a cross-linked (thermoset) polyimide resin and a polytetrafluoroethylene (PTFE) particles embedded within the polyimide resin. The PTFE particles are preferably more highly concentrated in the upper surface of the polyimide resin than at the lower surface in contact with the metal.

In use, a thermoplastic is extruded over the mandrel to define a tubular construct in a manner well known in the prior art. The polymer coating on the metal mandrel wire is smooth, durable and seals the metal surface preventing contamination of the tubular construct. In addition, due to the location of the PTFE particulate, the polymer coating has a relatively high bond strength with the outer surface of the mandrel, but practically does not bond at all with the plastic being extruded thereover. In addition, the polymer coating is elastic and is reduced in diameter when the mandrel is pulled down in diameter or elongated. Thus, the polymer-coated metal mandrel is easily released from the thermoplastic tubular construct when drawn down in diameter under tension to provide a plastic tubing free of the mandrel.

Additional objects and advantages of the invention will become apparent to those skilled in the art upon reference to the detailed description taken in conjunction with the provided figures.

### BRIEF DESCRIPTION OF THE DRAWINGS

FIG. 1 is a cross-section view of a mandrel according to the invention;

FIG. 2 is a schematic diagram of a polymer coating upon application to the mandrel;

FIG. 3 is a schematic diagram of the polymer coating after solidification on the mandrel;

FIGS. 4 and 5 illustrate the method of forming a plastic tubing using the mandrel of the invention.

### DETAILED DESCRIPTION

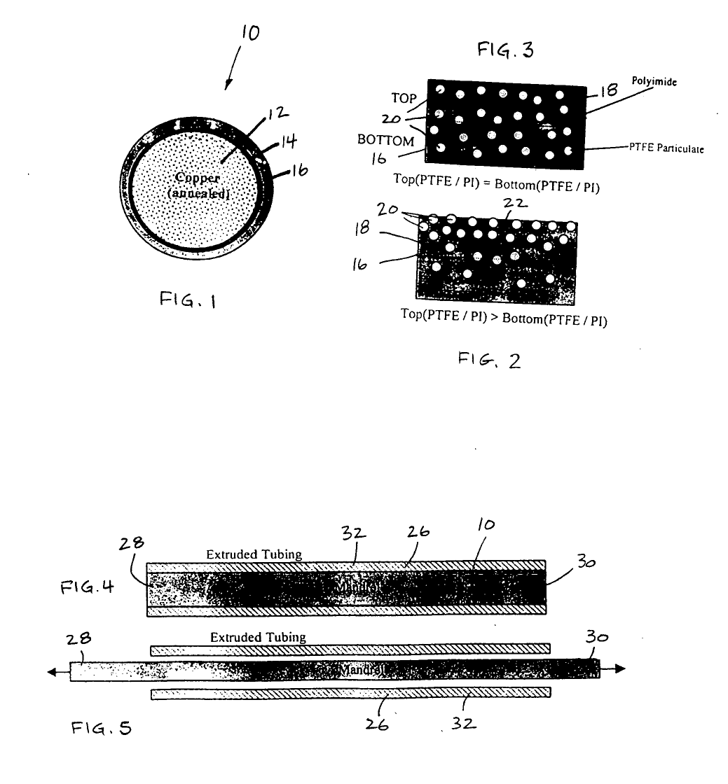

Turning now to FIG. 1, a mandrel 10 for the manufacture of a thermoplastic tubing is provided. The mandrel 10 includes a metal wire 12, preferably made of annealed copper, annealed stainless steel, or elastic nickel-titanium alloy (NiTi). The metal wire 12 may be covered (e.g., plated or otherwise coated) in silver 14 to provide a biocompatible barrier surface over the copper, though this is not necessary in view of the following. An elastic polymer coating 16 is provided on the metal wire 12 and over any silver plating 14 used. Referring to FIG. 2, the polymer coating 16 includes thermoset resin 18 which is preferably resistant to the high heat used during an thermoplastic extrusion. A preferred thermoset resin is a polyimide. The polymer coating 16 also includes particulate PTFE 20 dispersed within the resin 18. The PTFE 20 is preferably highly concentrated in the upper surface of the polyimide resin 16 and substantially lower concentrations of PTFE are located in the resin at or near the lower surface in contact with the metal 12, 14. By way of example and not limitation, the polyimide layer adjacent the upper surface comprises four percent (4±4%) polyimide and ninety-six percent (96±4%) PTFE (i.e., ˜1:20 ratio of polyimide to PTFE at or adjacent the upper surface) and the layer adjacent the lower surface comprises fifty-nine percent (59±4%) polyimide and forty-one percent (41±4%) PTFE (i.e., ˜3:2 ratio polymide to PTFE at or adjacent the lower surface). Even lower concentrations of PTFE can be provided at or near the lower surface, including a zero concentration. The polymer coating 16, with significantly lower concentrations of PTFE at the lower surface than the upper surface, bonds strongly to the metal wire 12, 14. The upper surface 22 of the polymer coating 16, with higher concentration of PTFE 20, does not bond to any thermoplastic material later applied during the tubing manufacturing process. As such, the coating 16 maximizes the release properties of the mandrel 10.

During manufacture of the mandrel 10, a flowable polymer coating 16 is extruded onto the outer surface of the wire 12 or the wire is pulled through the liquid state polymer 16 for the coating so that the wire picks up a volume of material. Referring to FIG. 3, at this stage, the PTFE particulate 20 is relatively evenly dispersed within the resin 18 of the polymer 16. The polymer-coated wire is then pulled through one or more round dies that remove all but a specified thickness of the polymer coating 16 (e.g., 0.0003-0.0005 inches) to define the outer diameter of the mandrel 10 and inner diameter of the tubing later formed thereover. Once the desired thickness of liquid polymer coating 16 is applied to the wire 12, the coated wire is moved into a thermal chamber (oven), where the liquid polymer coating is heated to drive off solvent materials allowing for a chemical reaction that results in the solidification of liquid coating. Referring to FIG. 3, during the solidification process, when the solvents are being driven out of the liquid coating, the PTFE particles 20 move toward the top or upper surface 22 of the polymer coating creating the desired stratification.

Turning now to FIG. 4, during manufacture of the tubing, the mandrel 10 is then either drawn through a pool of thermoplastic material 26 or thermoplastic material is extruded over a length of the mandrel. After the thermoplastic material 26 has solidified (via cooling or drying), a section of the mandrel with thermoplastic material thereon is cut at a desired length. Referring to FIG. 5, the ends 28, 30 of the mandrel 10 are then placed under tension causing the outer diameter of the mandrel 10 to be drawn down. The elastic polymer coating 16, strongly bonded to the metal wire 12 (14), stretches with the mandrel and also reduces in diameter. The PTFE 20 in the upper surface of the resin 18 prevents the mandrel from bonding with the plastic 26 being extruded thereover. Thus, the polymer-coated metal mandrel 10 is easily released from the thermoplastic tubular construct 32 when drawn down in diameter under tension, thereby freeing the plastic tubing 32 from the mandrel 10.

There have been described and illustrated herein embodiments of a mandrel and a method of manufacturing a plastic tubing using the mandrel. While particular embodiments of the invention have been described, it is not intended that the invention be limited thereto, as it is intended that the invention be as broad in scope as the art will allow and that the specification be read likewise. Thus, while annealed copper is preferred for the mandrel wire, it will be appreciated that the mandrel wire can alternatively made be made of other metals or metal alloys. In addition, while silver is a preferred plating metal for creating a barrier about the copper, other metals suitable for preventing contact between the wire mandrel and any plastics used can also be used. Also, while polyimide is a preferred resin in which the PTFE can be embedded, it is recognized that other resins, and preferably thermosets can also be used. Also, while PTFE is a preferred material for facilitating release of the mandrel, other low friction particles facilitating such release, especially other thermoplastic fluoropolymers, can be used as well. It will therefore be appreciated by those skilled in the art that yet other modifications could be made to the provided invention without deviating from its spirit and scope as claimed.

What is claimed is:

1. A mandrel for the manufacture of plastic tubing, comprising:
a) a metal wire having an outer diameter;
b) an elastic thermoset polymer coating on the wire, the polymer coating having a lower surface in contact with the metal wire and an upper surface; and
c) particles of a thermoplastic fluoropolymer provided in the polymer coating, where the particles are provided in a higher concentration nearer the upper surface than nearer the lower surface.

2. A mandrel according to claim 1, wherein:
the thermoplastic fluoropolymer is PTFE.

3. A mandrel according to claim 1, wherein:
at or near the upper surface the ratio of thermoset polymer to particles is approximately 1 to 20.

4. A mandrel according to claim 1, wherein:
at or near the lower surface, the ratio of thermoset polymer to particles is approximately 3 to 2.

5. A mandrel according to claim 1, wherein:
at or near the lower surface, the ratio of thermoset polymer to particles is greater than approximately 3 to 2.

6. A mandrel according to claim 1, wherein:
the polymer coating is a polyimide.

7. A mandrel according to claim 1, wherein:
the polymer coating is bonded to the wire and when the wire is placed under sufficient tension to reduce the outer diameter, the polyimide coating is also reduced in diameter.

8. A mandrel according to claim 1, wherein:
the metal wire is made of one of copper, stainless steel and nickel-titanium alloy.

9. A mandrel according to claim 8, wherein:
the copper is plated with a biocompatible surface.

10. A mandrel for the manufacture of plastic tubing, comprising:
a) a copper wire;
b) a metal or metal alloy plating on the wire to form a plated wire; and
c) an elastic polyimide coating bonded to the plated wire, wherein when the plated wire is placed under sufficient tension to draw down its diameter, the polyimide coating is also reduced in diameter.

11. A mandrel according to claim 10, further comprising:
particles of a thermoplastic fluoropolymer provided in the polyimide coating.

12. A mandrel according to claim 11, wherein:
the thermoplastic fluoropolymers is PTFE.

13. A mandrel according to claim 11, wherein:
the particles are not uniformly distributed in the polyimide coating.

14. A mandrel according to claim 11, wherein:
the polyimide coating has a lower surface in contact with the plated wire and an upper surface and the particles are provided in a higher concentration nearer the upper surface than nearer the lower surface.

15. A mandrel for the manufacture of tubing, comprising:
a metal wire having an elastic material coated thereon, the elastic material having a surface and including PTFE particles along its surface.

16. A mandrel according to claim 15, wherein:
the elastic material has a first concentration of PTFE particles at its surface and a second lower concentration of PTFE particles below its surface.

17. A method of manufacturing a mandrel, comprising:
a) providing a metal wire;
b) coating the metal wire with a flowable polymer coating, the polymer coating including particles of a thermoplastic fluoropolymer;
c) passing the polymer coated metal wire through at least one die to define a predetermined outer diameter to the polymer coated metal wire; and
d) heating the polymer coated metal wire to solidify the polymer on the wire and cause the particles of thermoplastic fluoropolymer to have a higher concentration at a surface of the mandrel than at an interface between the wire and the polymer coating.

18. A method according to claim 17, wherein:
said coating includes coating with a polymer coating including PTFE.

19. A method according to claim 18, wherein:
said coating includes coating with a polyimide.

20. A method according to claim 17, wherein:
said providing a metal wire includes providing a copper wire.

21. A method according to claim 17, wherein:
said providing a metal wire includes providing a silver covered copper wire.

22. A method according to claim 17, wherein:
said providing a metal wire includes providing a metal-coated metal wire.

23. A method according to claim 17, wherein:
said coating includes coating the polymer at a thickness of 0.0003-0005 inch.

24. A method of manufacturing plastic tubing, comprising:
a) providing a mandrel having a metal core and an outer surface including PTFE;
b) coating the outer surface of the mandrel in a flowable plastic material;
c) solidifying the plastic material on the mandrel;
d) placing ends of the mandrel under sufficient tension to reduce its diameter so as to cause separation of the mandrel from the plastic material dried thereover; and
e) removing the mandrel from within the plastic material to define the tubing.

25. A method according to claim 24, further comprising:
cutting the mandrel and the plastic material prior to placing the ends of the mandrel under tension.
